(19) United States
(12) Patent Application Publication
(10) Pub. No.: US 2007/0050370 A1
(43) Pub. Date: Mar. 1, 2007

(54) Methods, systems, and computer program products for managing the deployment of a reader network infrastructure

(76) Inventor: Michael Denny, Sharpsburg, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/211,779

(22) Filed: Aug. 25, 2005

(51) Int. Cl. G06F 17/30

(52) U.S. Cl. 707/10

(57) ABSTRACT

Methods, systems, and computer program products for managing deployment of a reader network infrastructure are provided. The method includes searching a database of records for a location corresponding with an event. The searching is performed in response to receiving a query for information relating to the event. The records link the location to the event. The method also includes contacting the location and requesting event data. In response to receiving the event data from the location, the method includes filtering the event data based upon the query, formatting the event data to coincide with the query, and transmitting a response to a source of the query, the response resulting from the filtering and formatting.

### BACKGROUND

The present invention relates generally to inventory management systems, and more particularly, to methods, systems, and computer program products for managing the deployment of a reader network infrastructure.

Inventory management systems today are striving to improve on communications technologies that provide the most current information on inventory levels and related data across widely dispersed locations. Many enterprises today use electronic data processing systems for managing physical inventory, such as radio frequency identification (RFID)-based systems. RFID enables inventory items to be tagged with information that is scanned into a receiving inventory system so that the movement of these items can be tracked as they proceed through a supply chain or distribution location.

Because RFID tags are generally proprietary implementations, the corresponding radio frequencies utilized for these tags often span a wide range of the frequency spectrum, which make them unsuitable for inter-enterprise applications. Recently, proposals for standardizing the RFID industry have been initiated by a consortium of industry experts through a non-profit organization called EPCGlobal, Inc.™. Many of these proposals are still in the planning phase. Despite these proposals for standardizing RFID technologies, there are still many challenges to be faced by enterprises using RFID technology in their inventory management systems. For example, the infrastructure necessary to conduct a regional or global inventory management system requires that the physical deployment of each of the reader network devices (e.g., edge servers, readers, etc.) be known to the hardware or host system implementing those processes. What is needed, therefore, is a hardware-independent solution for providing and managing the physical deployment of a reader network infrastructure.

### BRIEF SUMMARY

Exemplary embodiments include methods, systems, and computer program products for managing the deployment of a reader network. The method includes searching a database of records for a location corresponding with an event. The searching is performed in response to receiving a query for information relating to the event. The records link the location to the event. The method also includes contacting the location and requesting event data. In response to receiving the event data from the location, the method includes filtering the event data based upon the query, formatting the event data to coincide with the query, and transmitting a response to a source of the query, the response resulting from the filtering and formatting.

Additional embodiments include a system for managing the deployment of a reader network. The system includes a host system and a database of records stored on the host system. The system also includes an information services application executing on the host system and an aggregator application executing on the host system. The aggregator application includes an application programming interface. In response to receiving a query from the information services application for information relating to an event, the aggregator application performs a method. The method includes searching the database of records for a location corresponding with the event. The reader network records link the location to the event. The method also includes contacting the location via the host system and requesting event data relating to the query. In response to receiving the event data from the location, the method includes filtering the event data based upon the query, formatting the event data to coincide with the query, and transmitting a response to the information services application, the response resulting from the filtering and formatting.

Further embodiments include a computer program product for managing the deployment of a reader network. The computer program product includes instructions for implementing a method. The method includes searching a database of records for a location corresponding with an event. The searching is performed in response to receiving a query for information relating to the event. The records link the location to the event. The method also includes contacting the location and requesting event data. In response to receiving the event data from the location, the method includes filtering the event data based upon the query, formatting the event data to coincide with the query, and transmitting a response to a source of the query, the response resulting from the filtering and formatting.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is block diagram of a system upon which the reader network infrastructure management activities may be implemented in exemplary embodiments;

FIG. 2 is flow diagram describing a process for implementing the reader network infrastructure management activities in exemplary embodiments; and

FIG. 3 depicts a user interface screen of sample reader network records utilized by the reader network infrastructure management system in exemplary embodiments.

The detailed description explains exemplary embodiments, together with advantages and features, by way of example with reference to the drawings.

### DETAILED DESCRIPTION OF EXEMPLARY EMBODIMENTS

A reader network infrastructure management system is provided. The reader network infrastructure management system is a hardware-independent solution for providing and managing the physical deployment of a reader network infrastructure, such as one that conducts inventory management processes. The reader network infrastructure management system provides a middle layer of functionality that is transparent to the underlying inventory and enterprise applications. The functionality provided by the middle layer includes managing the physical deployment of reader network equipment, such as edge servers and readers, so that the underlying inventory and enterprise applications do not require any knowledge of the physical characteristics of the network architecture.

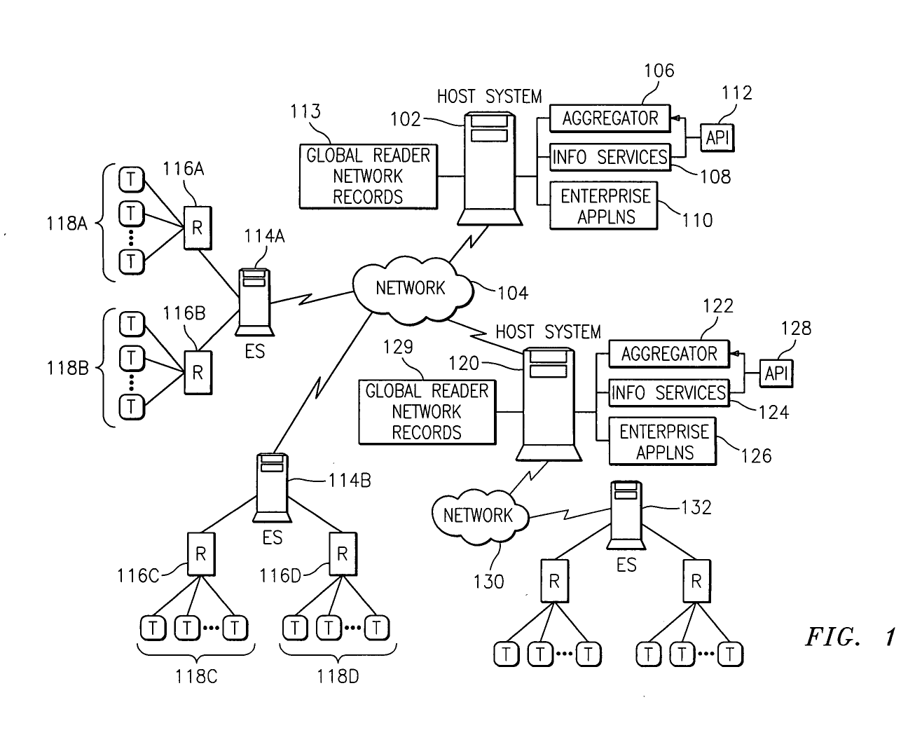

Turning now to FIG. 1, a system upon which the reader network infrastructure management activities may be implemented will now be described in accordance with exemplary embodiments. The system of FIG. 1 includes a host system 102 in communication with a network 104. The host system 102 may be implemented by an enterprise that conducts inventory management functions. In accordance with exemplary embodiments, the host system 102 executes an aggregator application 106, an information services application 108, and one or more enterprise applications 110. The aggregator application 106 may be implemented as a middle-layer application that is transparent to users of the host system 102 as will be described further herein. The aggregator application 106 maintains an inventory of the physical deployment characteristics of a reader network. The aggregator application 106 further collects information from edge servers relating to reader network activities, filters the collected information, and provides formatting capabilities of the collected information for presentation to a requesting entity.

Information services application 108 enables a user of host system 102 to perform queries of edge server activities or events. Information services application 108 may comprise multiple applications as desired by the host system enterprise. This collection of applications may be designed to leverage distribution of one or more specific items or articles within the inventory management system. The distribution may be geographically based or may be isolated to a specified location. For example, a user at the host system 102 may query a retailer at a location “Atlanta” for the number of articles currently on hand.

Enterprise applications 110 refer to a collection of enterprise-specific applications that provide a broad, or global, view of inventory information. Enterprise applications 110 provide, for example, total asset management capabilities.

In accordance with exemplary embodiments, aggregator application 106 includes an application programming interface (API) 112. API 112 provides formatting standards for queries of edge servers, as well as facilitates filtering criteria for these queries. The queries are generally initiated via the information services application 108 at host system 102. The standardization capabilities of API 112 may be implemented via any suitable radio frequency identification (RFID) industry standards, such as EPCGlobal, Inc.™ using application level event (ALE) protocols adopted by EPCGlobal members. EPCGlobal, Inc.™ is a non-profit organization that develops standards for RFID technologies. While applications 106-110 are shown in FIG. 1 as residing on a single server or host system 102 it will be understood that separate servers may be employed for implementing the applications 106-110 in order to realize the advantages of the reader network services. Thus, the embodiment shown in FIG. 1 is presented for illustrative purposes and is not to be construed as limiting in scope.

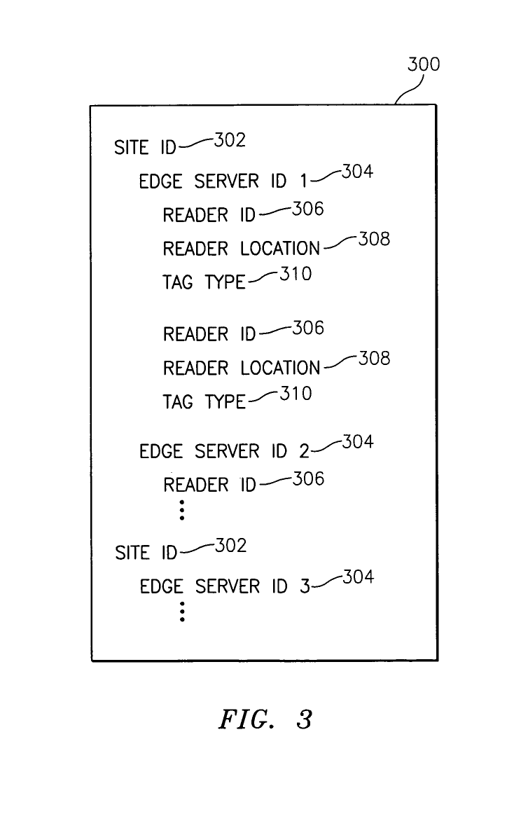

Host system 102 includes memory for storing enterprise information including global reader network records 113. Global reader network records are utilized by the aggregator application 106 for managing the physical deployment of a reader network infrastructure. A sample global reader network record is shown and described in FIG. 3.

Also included in the system of FIG. 1 are edge servers 114A and 114B. Edge servers 114A-114B may be implemented using any suitable type of processor device, such as a multi-purpose desktop computer. In exemplary embodiments, edge servers 114-114B refer to computer devices that are each dedicated to one or more readers. Edge servers 114A-114B collect raw data from the readers to which they are dedicated. Raw data includes a unique identifier for each article or set of articles that is scanned by the readers and may include other information as well. The raw data may be time-stamped or otherwise tracked such that the information scanned is associated with a time (e.g., time of arrival at the reader location, time of receipt at the edge server, etc.). Edge servers 114A-114B may be standards-compliant in accordance with any industry standards adopted by the reader network infrastructure system.

Edge servers 114A-114B may be in communication with readers via any suitable networking technologies, such as Wireless Fidelity (WiFi) or Internet Protocol (IP) based. If IP-based, the edge servers 114A-114B may communicate with readers over a local area network (LAN), wide area network (WAN), Internet, or other network configurations. Accordingly, edge servers 114A-114B may reside at the same location as their corresponding readers, or may be remotely located from the readers. For example, edge server 114A may reside in a data center building within a warehouse or distribution center.

As indicated above, edge servers collect information from one or more readers. As shown in the system of FIG. 1, readers 116A-116B are managed by edge server 114A and readers 116C-16D are managed by edge server 1141B. It will be understood by those skilled in the art, however, that any number of readers and edge servers may be implemented in order to realize the advantages of the invention. Readers 116A-116D receive information from articles or sets of articles (e.g., pallet, case, etc.) and transmit this information to corresponding edge servers. Readers 116A-116D may be implemented using any suitable type of device that sends signals to articles and receives information from the articles in response to these signals using RFID technology. Readers 116A-116D may be fixably mounted on equipment or may be portable hand held devices.

Also included in the system of FIG. 1 are tag sets 118A-118D. As shown in FIG. 1, tags 118A-118D correspond with readers 116A-116D, respectively. Tags 118A-118D refer to labels or items that are fixably attached to articles. Articles, in turn, refer to the inventory items (e.g., products, product containers, etc.) being tracked by the inventory processes used by the enterprise of host system 102. Tags 118A-118D may include a chip that stores the unique identification of the article, and an antenna for receiving signals (RFID) from the readers and emitting signals (RFID) back to the readers. While described herein as passive tags, it will be understood by those skilled in the art that active tags (e.g., tags that include recordable memory) may be used as well.

The system of FIG. 1 also includes a network 104 through which the host system 102 communicates with edge servers 114A-114B. Network 104 may comprise any suitable type of network including local area network (LAN), wide area network (WAN), the Internet, etc.

The reader network infrastructure management system enables the host system 102 to present event queries to one or more edge servers regarding inventory updates through a transparent layer implemented by the aggregator application 106. The aggregator application 106 uses the necessary protocols (e.g., EPCGlobal application Level Event protocol) to communicate the queries to the edge servers. Further, since the aggregator application 106 includes an API 112 for integrating different data types received from various edge servers, the aggregator application 106 is well suited for use in a federated reader network infrastructure. For example, the host system 102 may provide a top tier aggregator function for a number of lower level aggregator applications, such that the aggregator application 106 collects reader network information from multiple designated aggregator applications. This functionality will now be described with respect to FIG. 1.

As shown in FIG. 1, a second host system 120 is in communication with the host system 102 via network 104. The aggregator application 122 of the second host system 120 represents a second tier that provides information to the first tier aggregator application 106 of host system 102. The host system 120 may also include an information services application 124, enterprise applications 126, global reader network records 129, and an API 128 which are similar to the corresponding elements described above with respect to host system 102 and will not be described further. In addition, host system 120 may communication with specified edge servers, such as edge server 132 over a network 130 in a similar manner as that described above with respect to the host system 102.

In alternative exemplary embodiments, the aggregator application 106 may be implemented by a third party service provider, rather than the host system as shown in FIG. 1. The third party service provider may provide reader network infrastructure management services on behalf of the host system enterprise.

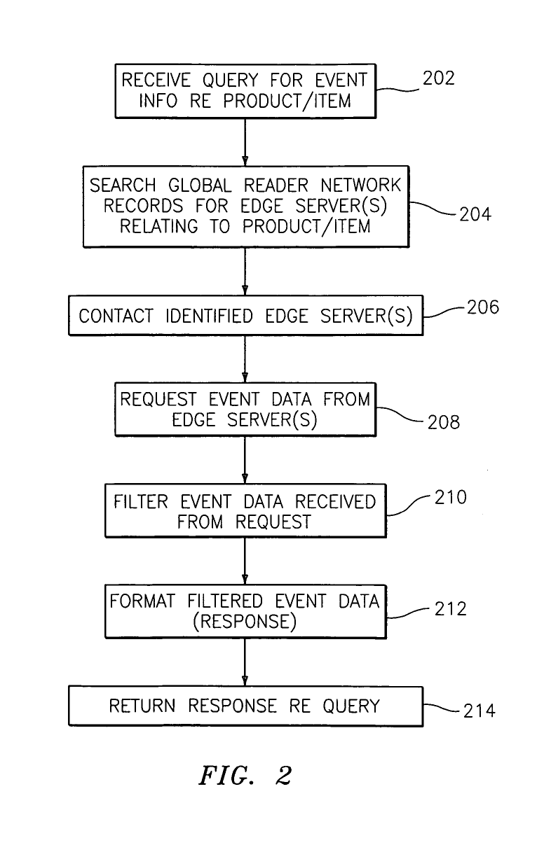

Turning now to FIG. 2, a flow diagram illustrating a process for implementing the reader network infrastructure management activities will now be described in accordance with exemplary embodiments. At step 202, the aggregator application 106 receives a request for event information relating to an article (e.g., product, item, group or case of products, etc.). For example, the request may be for a amount of product currently sitting on a shelf at a retail establishment or in a warehouse. The request may also be a production trigger, such as the desire to be notified when the 100^{th} widget is scanned in at a distribution center. In a further example, the request may be designed around a marketing campaign whereby the requester's query desires to know how much of a given product is at a location just prior to the initiation the marketing campaign so that the requester can measure the change in inventory over the course of the campaign.

The aggregator application 106 searches the global reader network records 113 in order to identify the location(s) of the article that is the subject of the request at step 204. A sample global reader network record is shown in FIG. 3. The record 300 may be configured to provide any type of information regarding the physical deployment of edge servers and readers throughout the reader network system. For illustrative purposes, the record 300 of FIG. 3 provides an identifier for each site or location (302), and within each site location 302 an identifier for each edge server 304 may be provided. In addition, since each edge server manages a set of readers, a reader identification 306 for each edge server may be provided in the record 300. Other information, such as the location of each reader 308 may be provided, as well as a tag type 310 associated with the reader. For example, each edge server may be deployed according to a tag type, which is designed for use at specified frequencies. This frequency information would be provided in the tag type field 310 of the global reader network record 300.

The aggregator application 106 retrieves the appropriate global reader network record information and directs the host system 102 to contact the edge server(s), which correspond to the request at step 206. A request for event data relating to the query (step 202) is transmitted to the edge server(s) at step 208. The aggregator application 106 formats this request for event data in a manner that is understood by the edge server(s).

The edge server(s) retrieve raw data received from the readers to which they are dedicated and provide this raw data to the host system 102. Upon receipt, at step 210, the aggregator application 106 filters the raw data to extract the data that is relevant to the request provided in step 202. The filtered data is then formatted by the aggregator application 106 at step 212 so that the data is in a form that is correlative to the initial request and forms the appropriate response. At step 214, the response is presented to the requester at the host system 102.

As described above, exemplary embodiments can be implemented in the form of computer-implemented processes and apparatuses for practicing those processes. Exemplary embodiments can also be implemented in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. Exemplary embodiments can also be implemented in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for managing deployment of a reader network infrastructure, comprising:
searching a database of records for a location corresponding with an event, the searching performed in response to receiving a query for information relating to the event, the records linking the location to the event;
contacting the location and requesting event data; and
in response to receiving the event data from the location:
filtering the event data based upon the query;
formatting the event data to coincide with the query; and
transmitting a response to a source of the query, the response resulting from the filtering and formatting.

2. The method of claim 1, wherein the location is a computer device that collects raw data from at least one reader, the at least one reader collecting identification information from at least one inventory article.

3. The method of claim 2, wherein the receiving event data includes receiving raw data from the computer device.

4. The method of claim 2, wherein the reader collects information from the at least one inventory article via a radio frequency identification tag on the at least one inventory article.

5. The method of claim 1, wherein the event data includes at least one of:
inventory status information; and
a production trigger.

6. The method of claim 1, wherein the records link the location to a tag type that specifies an inventory article via a radio frequency designated for the inventory article.

7. The method of claim 1, further comprising:
aggregating event information received from multiplication locations in response to a query for event information.

8. A system for managing deployment of a reader network infrastructure, comprising:
a host system;
a database of records stored on the host system;
an information services application executing on the host system; and
an aggregator application executing on the host system, the aggregator application including an application programming interface for enabling information exchange between the information services application and the aggregator application; wherein
in response to receiving a query from the information services application for information relating to an event, the aggregator application performs:
searching the database of records for a location corresponding with the event, the reader network records linking the location to the event;
contacting the location via the host system and requesting event data relating to the query;
in response to receiving the event data from the location:
filtering the event data based upon the query;
formatting the event data to coincide with the query; and
transmitting a response to the information services application, the response resulting from the filtering and formatting.

9. The system of claim 8, wherein the location is a computer device that collects raw data from at least one reader, the at least one reader collecting identification information from at least one inventory article.

10. The system of claim 9, wherein the receiving event data includes receiving raw data from the computer device.

11. The system of claim 9, wherein the reader collects information from the at least one inventory article via a radio frequency identification tag on the at least one inventory article.

12. The system of claim 8, wherein the event data includes at least one of:
inventory status information; and
a production trigger.

13. The system of claim 8, wherein the records link the location to a tag type that specifies an inventory article via a radio frequency designated for the inventory article.

14. A computer program product for managing deployment of a reader network, the computer program product including instructions for implementing a method, comprising the steps of:
searching a database of records for a location corresponding with an event, the searching performed in response to receiving a query for information relating to the event, the records linking the location to the event;
contacting the location and requesting event data; and
in response to receiving the event data from the location:
filtering the event data based upon the query;
formatting the event data to coincide with the query; and
transmitting a response to a source of the query, the response resulting from the filtering and formatting.

15. The computer program product of claim 14, wherein the location is a computer device that collects raw data from at least one reader, the at least one reader collecting identification information from at least one inventory article.

16. The computer program product of claim 15, wherein the receiving event data includes receiving raw data from the computer device.

17. The computer program product of claim 15, wherein the reader collects information from the at least one inventory article via a radio frequency identification tag on the at least one inventory article.

18. The computer program product of claim 14, wherein the event data includes at least one of:
inventory status information; and
a production trigger.

19. The computer program product of claim 14, wherein the records link the location to a tag type that specifies an inventory article via a radio frequency designated for the inventory article.

20. The computer program product of claim 14, further comprising instructions for implementing a method, comprising:
aggregating event information received from multiplication locations in response to a query for event information.
